(19) United States
(12) Patent Application Publication
(10) Pub. No.: US 2012/0280986 A1
(43) Pub. Date: Nov. 8, 2012

(54) Avionics System with Three Display Screens for Aircraft

(75) Inventors: Philippe CHABOT, St Aubin De Medoc (FR); Benoît GAUCHE, Saint Andre De Cubzac (FR); Nicolas BESNARD, St Medard En Jalles (FR); François LEULLIER, Bruges (FR)

(73) Assignee: THALES, Neuilly-sur-Seine (FR)

(21) Appl. No.: 13/464,845

(22) Filed: May 4, 2012

(30) Foreign Application Priority Data
May 5, 2011 (FR) 11 01386

(51) Int. Cl. G06T 15/00

(52) U.S. Cl. 345/419

(57) ABSTRACT

In the field of secure avionics systems for aircraft, a system comprises strictly three display units and three or four graphics generation computers connected to the display units. Each display unit comprises a single large-size screen able to display two totally independent half-images, and all the power supply, control and display circuits are doubled-up such that a single failure brings about the loss, at the most, of one half-screen. Each display unit is connected to two graphics generation computers at least, such that the failure of one computer does not affect the display.

### CROSS-REFERENCE TO RELATED APPLICATION

This application claims priority to foreign French patent application No. FR 1101386, filed on May 5, 2011, the disclosure of which is incorporated by reference in its entirety.

### FIELD OF THE INVENTION

The field of invention is that of aircraft instrument panels. Current instrument panels mainly include display screens for providing pilots the information required for flight control, navigation and more generally to achieve the mission in progress. The crew can interact with the screens by means of man-machine interfaces to select, monitor or modify the displayed data and parameters.

### BACKGROUND

Short- and medium-haul passenger transport planes, called “single aisle” planes, have relatively small cockpits where the successful integration of components required for flight control, navigation, monitoring and communications is essential for flight safety and to optimize the workload of the crew.

At the present time, technology provides for achieving large display screens, typically having a diagonal greater than or equal to 15 inches with excellent resolution. For example, large screens using “LCD” (“Liquid Crystal Display”) technology can be used. The arrival of these large display screens in the field of avionics is confronted by technical installation issues and requires a drastic reduction in the number of screens in the cockpit. The reduction in the number of screens then raises problems of availability of the plane in the event of a single failure able to bring about simultaneously the loss of several functions previously distributed over several screens. To address this issue, of course a minimum number of small screens in the cockpit can be retained. At the present time, the number of screens is a minimum of four and can increase to eight or more. The greater the number of screens, the higher the installation and wiring costs, and the greater the mass of the system.

### SUMMARY OF THE INVENTION

The avionics architecture according to the invention provides for producing an instrument panel that includes only three large display screens while providing sufficient availability of the avionics system in order to allow continuity of operations in complete safety in the event of a single failure until the next maintenance operation which can take place a few days after the failure is noted. The aim of this architecture, called a dual channel architecture, is to obtain, with only three large screens, the same operational availability as an avionics system with six display screens.

The architecture according to the invention is fully redundant, or “full dual”. Each screen includes two totally independent display half-screens, i.e. six half-screens in total. A single failure cannot cause the total loss of a large screen. The architecture thus provides either total availability of the six half-screens or availability of five half-screens out of six in the event of a single failure. Availability of primary information for the flight after a single failure is therefore ensured, while adhering to the flight safety objectives.

More specifically, the invention relates to a secure avionics system for aircraft, characterized in that it comprises strictly three display units and at least three graphics generation computers connected to the display units;
each graphics generation computer comprising:
   image generation means for generating at least two half-images;
   connection means connecting the said computer to at least a first display unit and to a second display unit;
each display unit comprising:
   connection means connecting the said display unit to at least a first graphics generation computer and to a second graphics generation computer;
   two identical and independent electronic addressing assemblies, each assembly being used to display a half-image on one half of the display screen of the display unit, the two displayed half-images coming from the same graphics generation computer;
   electronic “switching” means for displaying either the two half-images from the first graphics generation computer or the two half-images from the second graphics generation computer.

Advantageously, the avionics system includes only three graphics computers, each graphics computer being capable of generating four half-images.

Advantageously, the avionics system includes only four graphics generation computers.

Advantageously, two of the graphics generation computers include video image processing means and each of the said graphics generation computers is connected to a head-up display unit.

Advantageously, each display unit comprises a single liquid crystal display screen made up of two half-screens, each half-screen being addressed by an independent control circuit assembly, an independent lighting assembly and an independent electrical power supply.

Advantageously, the image generation means of each computer generate either two independent half-images or two half-images forming one and the same continuous image representative of data required for flight control, navigation, aircraft monitoring or airport taxiing.

Advantageously, the four graphics computers are grouped together in pairs, to form two dual graphics computers, each one capable of generating four independent half-images or four half-images forming two continuous images representative of data required for flight control, navigation, aircraft monitoring or airport taxiing.

### BRIEF DESCRIPTION OF THE DRAWINGS

The invention will be better understood and other advantages will become clear from reading the following description given in a non-limiting manner and with reference to the accompanying drawings in which:

FIG. 1 represents the general block diagram of the avionics system according to the invention, in a preferred architecture with four graphics computers;

FIG. 2 represents the general block diagram of a display unit according to the invention;

FIG. 3 represents a variant of the general block diagram of the avionics system with four graphics computers comprising two head-up displays;

FIG. 4 represents the general block diagram of the avionics system according to the invention in an alternative architecture with three graphics computers;

FIG. 5 represents a variant of the general block diagram of the avionics system of FIG. 4 with three graphics computers.

### DETAILED DESCRIPTION

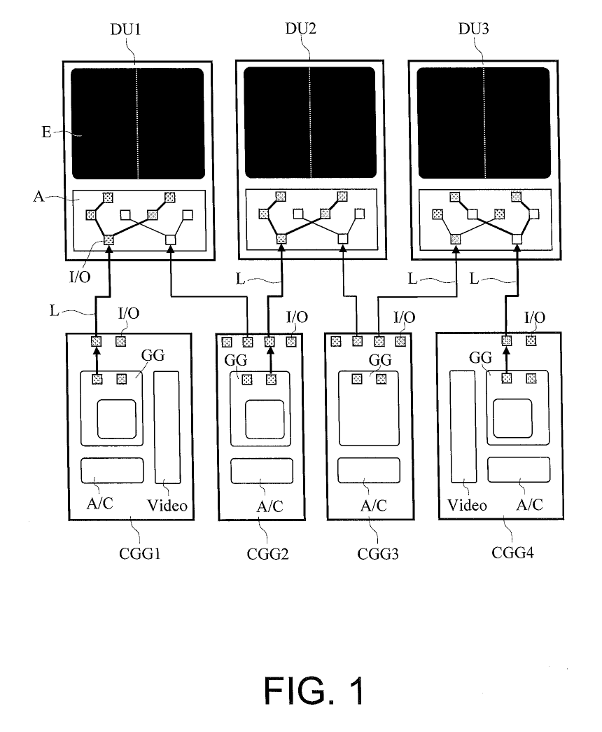

By way of a first non-limiting example, FIG. 1 represents the general block diagram of an avionics system according to the invention in a preferred architecture with four graphics computers. It comprises three display units denoted by DU1, DU2 and DU3, and four graphics generation computers denoted by CGG1, CGG2, CGG3 and CGG4. These computers are connected to the display units via electronic or optical links denoted by L. The optical links can be implemented according to the ARINC 818 standard.

The display units are arranged in a row in the cockpit. Each pilot has in front of them a side screen displaying the data required for flight control and navigation. A central screen displays information on the engines and systems of the aircraft. The computers are connected to the rest of the avionics system comprising the various sensors of the aircraft and the aircraft data exchange and communications networks.

The functions of the graphics computers are to calculate, from aircraft systems data, the animation logic of the symbols and to plot them. These functions are acquisition, transmission, interaction of signals, calculation of parameters and their graphical representations.

To provide these functions, each graphics generation computer CGG mainly comprises:
means I/O and A/C for interconnection with the rest of the avionics system;
image generation means GG for generating two half-images;
connection means I/O connecting the computer to a first display unit and to a second display unit. These means are represented by small squares in FIG. 1 and in the other drawings.

In FIG. 1, the two computers CGG1 and CGG4 also comprise means for processing video images prior to display.

The image generation means of each computer generate either two independent half-images or two half-images forming one and the same continuous image. These images are representative of data required for flight control, navigation, aircraft monitoring or airport taxiing. These main types of display are called “EFIS” (“Electronic Flight Instrument System”) and “ECAM” (“Electronic Centralized Aircraft Monitoring”). Depending on the displayed data, the displays are called:
Flight control data: “PFD”, for “Primary Flight Display”;
Navigation data: “ND”, for “Navigation Display”;
Engine monitoring and alarm management data: “EWD”, for “Engine Warning Display”;
General aircraft system data: “SD”, for “System Display”;
Airport-related data: “ANF”, for “Airport Navigation Functions”.

The four graphics computers can be grouped together in pairs, to form dual graphics computers, capable of generating four independent half-images or four half-images forming two continuous images representative of data required for flight control, navigation, aircraft monitoring or airport taxiing.

Each display unit DU mainly comprises:
connection means I/O connecting the display unit to a first graphics generation computer and to a second graphics generation computer;
two identical and independent electronic addressing assemblies, each assembly being used to display a half-image on one half of the display screen E of the display unit, the two displayed half-images coming from the same graphics generation computer;
electronic “switching” means A for displaying either the two half-images from the first graphics generation computer or the two half-images from the second graphics generation computer.

More specifically, the display screen can be an “LCD” (“Liquid Crystal Display”) technology screen including a single display matrix which is made up of two half-screens with separate control, referred to as “double driving”. By way of example, the size of the screen can be 15 inches which corresponds to a screen diagonal of 38 centimetres.

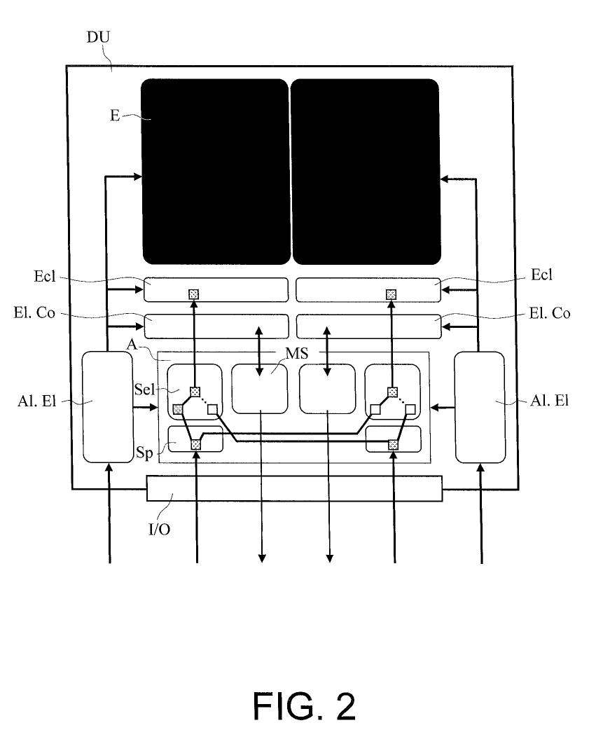

FIG. 2 represents the detailed block diagram of an LCD display unit DU. It comprises a screen E. This screen is a single matrix of elementary pixels able to be controlled by two totally separate electronic control or addressing assemblies for creating two totally independent images. Each electronic assembly comprises an electrical power supply Al.El fed by the onboard power supply network, generally 115 volts AC. This electrical power supply feeds a control electronics unit EI.Co, also called an “LCD Driver”, a backlighting arrangement Ecl which can be provided by light-emitting diodes, and a half-screen. In FIGS. 1 to 5, to indicate that the screens are made up of half-screens, the screens are drawn in black with a white separation line. In reality, the separation line between the two half-screens is invisible to the user. Indeed, it is possible to split supply lines feeding a large screen into two with a precision of the order of a pixel.

With this arrangement, in the event of a single failure, i.e. in the event that an electrical power supply, a control electronics unit, a backlighting arrangement or a half-screen fails, the other half-screen can be kept operational. Thus, the crew retains five half-screens operational out of six, which is acceptable on the flight safety plan. Under certain conditions, this also allows the plane to continue to be operated for several days, until the next maintenance operation.

It is to be noted that it is then possible to reconfigure this screen such that the primary data to control the plane remain available in the line of the pilot. In the event of the total loss of a screen, the data could be reconfigured on one of the two remaining screens, but control of the plane would be made more difficult insofar as the flight control data required would no longer be in the line of the pilot, considering the size of the large screens. The pilot would need to adapt mentally in order to return to his/her usual frame of reference.

In the architecture with three screens and four computers, each display unit DU is connected to two graphics generation computers. Each computer generates two half-images. The electronic switching means A, which comprise distribution means Sp and selection means Sel for the video signals, are for selecting one of the two computers and sending the images from this computer to the half-screens.

Each display unit DU includes two independent monitoring means MS which are for detecting possible failures. In the event that the selected computer fails, the switching means selects the images from the second computer in order to send them to the two half-screens. It is observed that, in this case, the failure is transparent to the crew members, who retain all of these six half-screens.

By way of example, in FIGS. 1, 3, 4 and 5, the electronic links connecting the graphics computers to the display units under nominal operating mode have been represented by thick lines. In FIGS. 1, 3, 4 and 5, the electronic links connecting the graphics computers to the display units in the event of failure have been represented by thin lines.

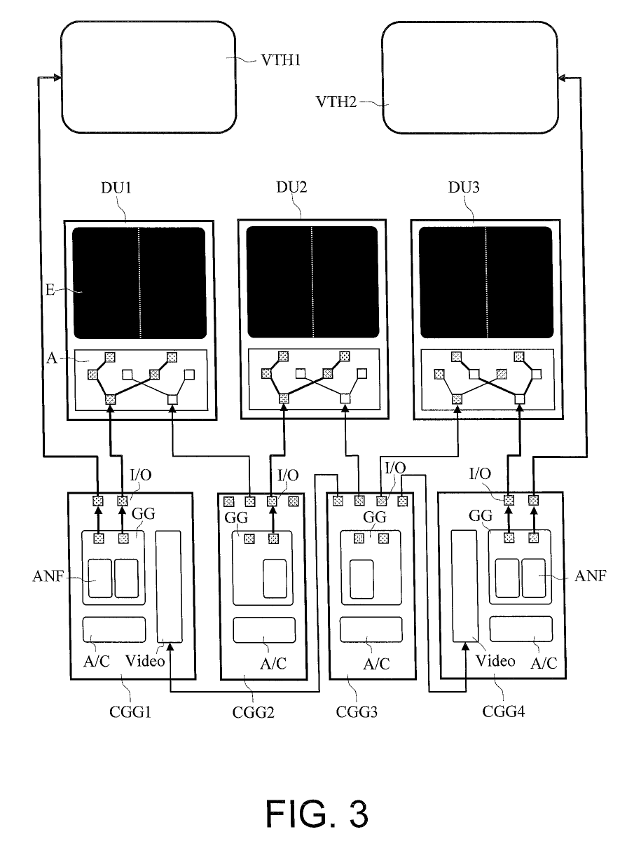

In this architecture with three screens and four computers, under normal operating mode, one of the four computers is unused. This additional computation capacity given by the fourth computer can be used to host additional functions in the cockpit. Thus, as seen in FIG. 3, the control of two Head-Up Displays (HUDs), denoted by HUD1 and HUD2 in FIG. 3, can be incorporated. The Airport Navigation Function (ANF) can also be incorporated. These images are transmitted by video links.

In the event that a graphics generation fails, the ANF function which is not critical is abandoned in order to reconfigure the main display which has been lost.

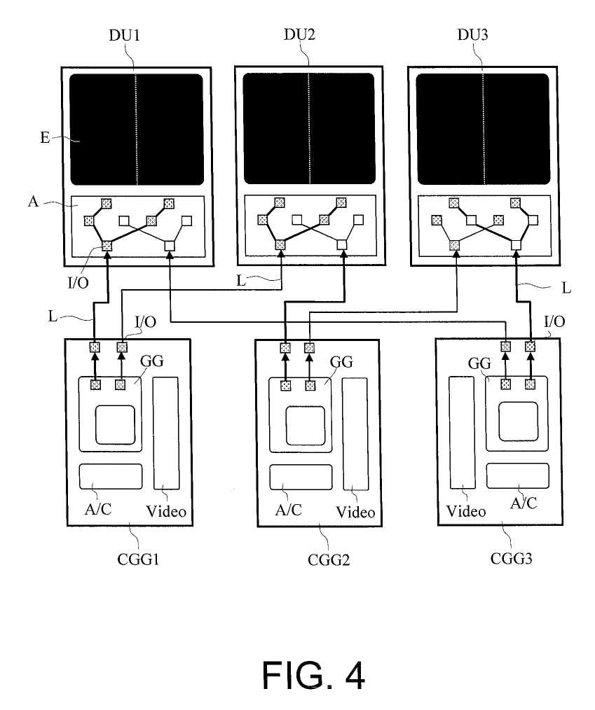

An alternative architecture to the preceding one and including only three graphics computers instead of four is represented in FIG. 4; each display unit DU is connected to two graphics generation computers.

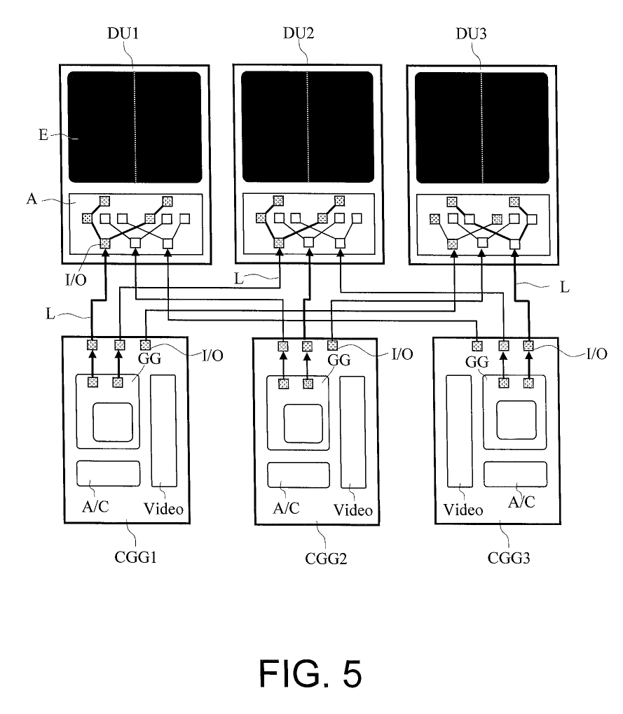

In one variant of this alternative architecture with three screens and three graphics computers, represented in FIG. 5, each display unit DU is connected to three graphics generation computers, thus providing for greater flexibility in terms of the reconfiguration capability of the system.

In these two alternative architectures with three screens and three graphics computers, each computer nominally generates two half-images or one complete image. In the event that a computer fails, one of the two remaining computers then generates four half-images or two complete images, such that the failure is transparent to the crew members, who retain all of their six half-screens.

The electronic switching means A are for selecting one of the computers and sending the images from this computer to the half-screens.

1. A secure avionics system for aircraft, comprising strictly three display units and at least three graphics generation computers connected to the display units;
each graphics generation computer comprising:
image generation means for generating at least two half-images;
connection means connecting said computer to at least a first display unit and to a second display unit;
each display unit comprising:
connection means connecting said display unit to at least a first graphics generation computer and to a second graphics generation computer;
two identical and independent electronic addressing assemblies, each assembly being used to display a half-image on one half of the display screen of the display unit, the two displayed half-images coming from the same graphics generation computer;
electronic “switching” means for displaying either the two half-images from the first graphics generation computer or the two half-images from the second graphics generation computer.

2. The secure avionics system for aircraft according to claim 1, wherein the avionics system comprises strictly three graphics generation computers, each graphics computer being capable of generating four half-images.

3. The secure avionics system for aircraft according to claim 1, wherein the avionics system comprises strictly four graphics generation computers.

4. The secure avionics system for aircraft according to claim 1, wherein two graphics generation computers include video image processing means and each of said graphics generation computers is connected to a head-up display unit.

5. The secure avionics system for aircraft according to claim 1, wherein each display unit comprises a single liquid crystal display screen made up of two half-screens, each half-screen being addressed by an independent control circuit assembly, an independent lighting assembly and an independent electrical power supply.

6. The secure avionics system for aircraft according to claim 1, wherein the image generation means of each graphics generation computer generate two independent half-images representative of data required for flight control, navigation, aircraft monitoring or airport taxiing.

7. The secure avionics system for aircraft according to claim 1, wherein the image generation means of each graphics generation computer generate two independent half-images forming one and the same continuous image representative of data required for flight control, navigation, aircraft monitoring or airport taxiing.

8. The secure avionics system for aircraft according to claim 3, wherein the four graphics computers are grouped together in pairs, to form dual graphics computers, capable of generating four independent half-images or four half-images forming two continuous images representative of data required for flight control, navigation, aircraft monitoring or airport taxiing.
